(19) United States
(12) Patent Application Publication
(10) Pub. No.: US 2010/0154128 A1
(43) Pub. Date: Jun. 24, 2010

(54) METHOD FOR PRODUCING LEATHER

(75) Inventors: Susanne Petrovic, Ludwigshafen (DE); Andreas Seitz, Birkenheide (DE); Peter Danisch, Ludwigshafen (DE); Hartmut Bethge, Ludwigshafen (DE); Werner Janson, Duerkheim (DE); Hubertus Peter Bell, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: Basf Aktiengesellschaft Patents, Trademarks and Licenses, Ludwigshafen (DE)

(21) Appl. No.: 11/993,730

(22) PCT Filed: Jun. 22, 2006
(86) PCT No.: PCT/EP06/63447

§ 371 Date: Dec. 21, 2007

(30) Foreign Application Priority Data
Jun. 23, 2005 (DE) 10 2005 029 627.0

(51) Int. Cl. C14C 9/02; C08K 5/01

(52) U.S. Cl. 8/94.1 R; 524/556

(57) ABSTRACT

A process for the production of leather, wherein tanned animal hides are treated in step (A) with an aqueous liquor which comprises
(a) at least one copolymer obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin
   and, if appropriate, hydrolysis and/or at least partial neutralization,
(b) at least one paraffin which is liquid at room temperature,
(c) at least one synthetic nonionic emulsifier,
   the aqueous liquor being free of silicones, and furthermore silicone-free aqueous formulations and their use.

The present invention relates to a process for the production of leather, wherein tanned animal hides are treated in step (A) with an aqueous liquor which comprises
(a) at least one copolymer obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin
   and, if appropriate, hydrolysis and/or at least partial neutralization,
(b) at least one paraffin which is liquid at room temperature,
(c) if appropriate, at least one synthetic nonionic emulsifier,
   the aqueous liquor being free of silicones.

The present invention further relates to silicone-free aqueous formulations free of natural fats and their use.

The requirements with respect to leather have greatly increased in the past years. In particular, greater importance is attached to good physical properties, such as lightfastness, and furthermore little fogging (evaporation of volatile constituents from the leather), little heat yellowing, a low level of VOC (volatile organic compounds) and freedom from odor.

In conventional fatliquoring of leather with natural fats or oils, it is frequently observed that the fatliquored leather changes disadvantageously in the course of time. For example, it may yellow, particularly at elevated temperatures, acquire an unpleasant odor or subsequently harden. In addition, strong blooming of natural fats or oils is sometimes observed after a certain time of use. In addition, there are often difficulties in meeting the requirements of the automotive industry with regard to fogging, i.e. FOG or VOC and migration, with naturally fatliquored leathers (Fogging DIN 75201/ISO6452; static headspace RAL-GZ 479/VDA 277 (PV 3341); dynamic headspace PB VWL 709 (method of Daimler-Chrysler)) (migration fastness DIN 3353; drop test: migration and stability to aging, BASF method (48 h at 100° C./48 h at 55° C. and 95% relative humidity)). Fully synthetic fatliquoring agents which dispense with the use of natural components in order to guarantee good physical fastnesses of the leathers produced generally do not achieve satisfactory softness on leather.

A fundamental difficulty in the production of soft leathers is moreover in preventing the leathers from becoming loose-grained. It is often observed that, the softer a leather, the more the loose-grained character increases.

A further difficulty with the use of natural fatliquoring agents occurs with fatliquoring leathers which have been rendered hydrophobic. According to a widely used test, the Maeser test, leather of adequate quality must be capable of withstanding at least 15 000 so-called Maeser flexes before significant penetration of water can be detected. Many natural fatliquoring agents adversely affect the water repellency, i.e. the Maeser values usually achievable by a certain procedure can no longer be achieved if the leather was treated with natural fats in the retanning.

With purely polymeric water repellents, it is also not possible reliably to achieve good Maeser values. This is because of, for example, the changing quality of the leather, which is influenced, for example, by the quality of the raw hide, and furthermore, for example, by the water quality, in particular by the hardness of the water used in the tanning, and further influencing parameters. With silicones, better quality can often be achieved; owing to the higher prices of silicones in comparison with polymer fatliquors, however, expensive water repellency steps with silicones are economical only when it is desired to produce high-quality leather for high-price applications.

Besides, it is observed that, with the use of silicones for imparting water repellency, leather which tends to be loose-grained is frequently obtained.

DE 26 29 748 discloses copolymers of maleic anhydride and monoolefins, such as, for example, an α-olefin having an average chain length of 14 to 18 carbon atoms, which are used for filling and fatliquoring of leather. The relevant copolymers are prepared in an organic solvent, such as, for example, paraffin or dialkylbenzene. Working-up does not ensure that the relevant organic solvent is completely separated off.

DE 39 26 167 A1 emphasizes that it is important for the copolymers used, which are based on long-chain olefins and ethylenically unsaturated dicarboxylic anhydrides, to be free of organic solvents since it is desired to use them for imparting water repellency to leathers and fur skins. DE 39 26 167 A1 therefore proposes using copolymers prepared by mass polymerization and based on long-chain olefins and ethylenically unsaturated dicarboxylic anhydrides.

WO 95/20056 proposes using aqueous solutions or dispersions of copolymers for fatliquoring and filling leathers, the solutions or dispersions comprising emulsifier and copolymer which is prepared, for example, from monoethylenically unsaturated C₄-C₁₂-dicarboxylic anhydrides and C₆-C₄₀-monoolefins. No marked water repellency effect is observed (page 8, lines 35-39). The fact that no organic solvents are concomitantly used is emphasized as being advantageous.

It is the object to provide a process for the production of soft leathers having excellent physical fastnesses, by means of which process the disadvantages known from the prior art are avoided. It is furthermore the object to provide formulations with the aid of which soft leathers having particularly good physical fastnesses can be produced.

Accordingly, the process defined at the outset was found.

In the process according to the invention, tanned animal hides are treated in step (A) with an aqueous liquor which comprises
(a) at least one copolymer obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin
   and, if appropriate, hydrolysis and/or at least partial neutralization,
(b) at least one paraffin which is liquid at room temperature,
(c) if appropriate, at least one synthetic nonionic emulsifier,
   the aqueous liquor being free of silicones.

Animal hides may originate, for example, from cattle, calves, pigs or any desired other animals. Tanned animal hides may be whole animal hides or parts of animal hides, for example strips or halves of animal hides.

The process according to the invention starts from animal hides tanned by any desired processes, for example by polymer tanning, enzymatic tanning, mineral tanning, in particular chrome tanning with one or more Cr(III) compounds, tanning with carbonyl compounds, such as, for example, glutardialdehyde, tanning with syntans or vegetable tanning agents, resin tanning agents or combinations of the abovementioned tanning processes. It is preferable to start from, for example, animal hides tanned by chrome tanning with one or more Cr(III) compounds, or tanning with resin tanning agents or with carbonyl compounds, such as, for example, glutardialdehyde. Animal hides used as starting materials for the process according to the invention may already have been subjected to one or more retanning steps.

In a preferred embodiment of the present invention, tanned animal hides are animal hides tanned with Cr(III) compounds (wet blue).

In another preferred embodiment of the present invention, tanned animal hides are chromium-free, in particular animal hides tanned with carbonyl compounds, such as, for example, glutardialdehyde (wet white).

The process according to the invention is carried out in aqueous liquor, for example having a liquor ratio in the range from 100 to 300% by weight, based on the shaved weight.

Aqueous liquor used in the process according to the invention may have a pH in the range from 4.2 to 9.5, preferably from 4.5 to 7.

Aqueous liquor used in step (A) of the process according to the invention is free of silicones, i.e. neither one silicone nor a plurality of silicones has been added to the aqueous liquor used in step (A).

In a special embodiment of the present invention, the liquor used in step (A) is free of natural fats, i.e. neither one natural fat nor a plurality of natural fats has been added to the aqueous liquor used in step (A).

In an embodiment of the present invention, the process according to the invention is carried out at a temperature in the range from 10 to 65° C., preferably from 20 to 40° C.

The process according to the invention can be carried out in vessels customary in tanning, for example by drumming in barrels, for example in barrels having internals, or in rotated drums.

The aqueous liquor used in step (A) comprises
(a) at least one copolymer obtainable by copolymerization of
(a1) at least one ethylenically unsaturated C₄-C₈-dicarboxylic acid, for example maleic acid, fumaric acid, itaconic acid, metaconic acid or citraconic acid, preferably maleic acid, or of a derivative of an ethylenically unsaturated C₄-C₈-dicarboxylic acid, for example of the di- or preferably mono-C₁-C₁₀-alkyl ester and in particular of the anhydride; preferred (a1) are itaconic anhydride, citraconic anhydride and very particularly preferably maleic anhydride,
(a2) at least one C₈-C₁₀₀-α-olefin, branched or straight-chain, for example diisobutene, α-C₁₀H₂₀, α-C₁₂H₂₄, α-C₁₄H₂₈, α-C₁₆H₃₂, α-C₁₈H₃₆, α-C₂₀H₄₀, α-C₂₂H₄₄, α-C₂₄H₄₈, α-C₃₀H₆₀, α-C₄₀H₈₀, α-triisobutene, α-tetraisobutene, and polyisobutene having an average molecular weight M_{w} in the range from 250 to 1000 g/mol; α-C₁₀H₂₀, α-C₁₂H₂₄, α-C₁₄H₂₈, α-C₁₆H₃₂, α-C₁₈H₃₆, α-C₂₀H₄₀, α-C₂₂H₄₄, α-C₂₄H₄₈ and α-C₃₀H₆₀ are particularly preferred.

After the copolymerization, hydrolysis and/or at least partial neutralization can be effected, for example, by reaction with a basic alkali metal compound, with ammonia or with one or more organic amines. It is preferable to hydrolyze and to at least partially or quantitatively neutralize in one step with an aqueous solution of a basic alkali metal compound.

Preferred aqueous solutions of a basic alkali metal compound are, for example, aqueous potassium hydroxide solution, aqueous sodium hydroxide solution, an aqueous solution of sodium or potassium carbonate or sodium or potassium bicarbonate.

Further suitable bases are amines, unsubstituted or substituted by one to four identical or different organic radicals. Suitable organic radicals are, for example, phenyl,
C₁-C₁₀-alkyl, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, preferably linear C₁-C₆-alkyl, such as methyl, ethyl, n-propyl, n-butyl, n-pentyl, n-hexyl, isohexyl, sec-hexyl, particularly preferably C₁-C₄-alkyl, such as methyl, ethyl, n-propyl, n-butyl, very particularly preferably methyl and ethyl,
   and ω-hydroxy-C₁-C₄-alkyl, for example 4-hydroxybutyl, 3-hydroxypropyl and in particular 2-hydroxyethyl.

Very particularly preferred amines are ammonia, diethylamine, triethylamine, diethanolamine, N-methyldiethanolamine, N-methylethanolamine, N-n-butyldiethanolamine, N-n-butylethanolamine and N,N-dimethylethanolamine.

In an embodiment of the present invention, copolymer (a) has an average molecular weight M_{w} in the range from 800 to 50 000 g/mol, preferably from 1000 to 20 000 g/mol, determined by gel permeation chromatography of the corresponding unhydrolyzed copolymer in THF (tetrahydrofuran) with polystyrene calibration.

In an embodiment of the present invention, the molar ratio of (a1) to (a2) is in the range from 0.8:1 to 2:1.

The preparation of copolymers (a) used in the process according to the invention is known per se. It can be effected, for example, by free radical copolymerization of the comonomers (a1) and (a2) at temperatures in the range from 50 to 250° C., preferably in the range from 80 to 200° C. Copolymers (a) used in the process according to the invention can be prepared by mass copolymerization or solution copolymerization, for example in a paraffin which is liquid at room temperature.

If it is desired to effect at least partial neutralization, reaction with water or aqueous base, for example at temperatures in the range of, preferably, from 20 to 150° C., can be effected. The preferred temperature range for the hydrolysis is from 60 to 100° C.

Hydrolysis is preferably effected completely or to a degree of at least 95 mol %. Examples of copolymers (a) are copolymers, if appropriate hydrolyzed and at least partially neutralized with sodium hydroxide solution, of

1 mol of maleic anhydride and 0.9 mol of diisobutene
1 mol of maleic anhydride and 1 mol of diisobutene
1 mol of maleic anhydride and 0.8 mol of α-C₁₀H₂₀
1 mol of maleic anhydride and 1 mol of α-C₁₀H₂₀
1 mol of maleic anhydride and 1 mol of α-C₁₂H₂₄
1 mol of maleic anhydride and 1 mol of α-C₁₆H₃₂
1 mol of maleic anhydride and 1 mol of α-C₁₈H₃₆
1 mol of itaconic anhydride and 1 mol of α-C₁₈H₃₆
1 mol of maleic anhydride and 1 mol of n-C₂₀₋₂₄-olefin
1 mol of maleic anhydride and 0.1 mol of α-C₁₀H₂₀ and 0.9 mol of α-C₃₀H₆₀
1 mol of maleic anhydride and 0.3 mol of α-C₁₂H₂₄ and 0.7 mol of n-C₂₀₋₂₄-olefin
1 mol of maleic anhydride and 0.7 mol of α-C₁₂H₂₄ and 0.3 mol of polyisobutene having a molecular weight M_{w} of 500 g/mol,
1 mol of maleic anhydride and 0.3 mol of α-C₁₂H₂₄ and 0.7 mol of n-C₂₀₋₂₄-olefin
1 mol of maleic anhydride and 0.6 mol of α-C₁₂H₂₄ and 0.4 mol of n-C₂₀₋₂₄-olefin
1 mol of maleic anhydride and 0.5 mol of α-C₁₆H₃₂ and 0.5 mol of n-C₂₀₋₂₄-olefin
1 mol of maleic anhydride and 0.7 mol of α-C₁₈H₃₆ and 0.3 mol of n-C₂₀₋₂₄-olefin
1 mol of maleic anhydride and 0.9 mol of n-C₂₀₋₂₄-olefin and 0.1 mol of polyisobutene having a molecular weight M_{w} of 500 g/mol.

Data in moles represent in each case the molar ratio.

For carrying out the process according to the invention, at least one paraffin (b) which is liquid at room temperature, also referred to as liquid paraffin, is furthermore used. Paraffins which are liquid at room temperature include in each case crude paraffin oils which are liquid at room temperature, refined slack wax fractions, deoiled crude paraffins, semi-refined and fully refined liquid paraffins and bleached liquid paraffins. In relation to the present invention, paraffins are understood as meaning saturated hydrocarbons, branched or preferably linear, cyclic or preferably acyclic, individually or preferably as a mixture of a plurality of saturated hydrocarbons. In relation to the present invention, paraffins are preferably mixtures of saturated C₆-C₃₀-hydrocarbons, in particular mixtures of saturated C₈-C₃₀-hydrocarbons.

In an embodiment of the present invention, paraffin (b) which is liquid at room temperature is chosen from mixtures of saturated C₆-C₃₀-hydrocarbons, in particular mixtures of saturated C₈-C₃₀-hydrocarbons, of which less than 10% by weight, preferably less than 5% by weight and particularly preferably less than 2% by weight are branched and the remainder are linear, determinable, for example, by gas chromatography.

In an embodiment of the present invention, paraffin (b) which is liquid at room temperature is chosen from mixtures of saturated C₆-C₃₀-hydrocarbons, in particular mixtures of saturated C₈-C₃₀-hydrocarbons, of which less than 5% by weight and preferably less than 2% by weight are cyclic and the remainder acyclic.

In an embodiment of the present invention, paraffin (b) which is liquid at room temperature has a dynamic viscosity in the range from 0.3 to 100 mPa·s, preferably from 0.4 to 50 mPa·s, particularly preferably from 0.5 to 10 mPa·s, measured at 20° C.

In an embodiment of the present invention, paraffin (b) which is liquid at room temperature has a broad boiling range of from 70 to 250° C., preferably from 125 to 230° C., determined at atmospheric pressure.

For carrying out the process according to the invention, at least one synthetic nonionic emulsifier (c) can furthermore be used, which, in an embodiment of the present invention, may have an HLB value in the range from 1 to 20, preferably up to 18 (hydrophilic/lipophilic value, determined according to

$$HLB = 20 \frac{{M}_{H}}{{M}_{tot}}$$

where M_{H}=molecular weight of the hydrophilic moiety and Mₜₒₜ=molecular weight of the total emulsifier molecule, described in H. Stache, Tensidtaschenbuch, Carl Hanser Verlag, Munich, 1981).

In another embodiment of the present invention, synthetic nonionic emulsifier (c) can be omitted when carrying out the process according to the invention.

In a preferred embodiment, at least two different synthetic nonionic emulsifiers (c1) and (c2) are used for carrying out the process according to the invention, of which emulsifiers, in an embodiment of the present invention, one may have an HLB value in the range from 1 to 10 and the other may have an HLB value in the range from 10 to 20, preferably up to 18. Where it is desired to use two different synthetic nonionic emulsifiers (b), it is ensured that at least one synthetic nonionic emulsifier has an HLB value which differs from 10.

In an embodiment of the present invention, nonionic synthetic emulsifiers (c) are selected from polyalkoxylated fatty alcohols, polyalkoxylated oxo alcohols, polyalkoxylated fatty acids, polyalkoxylated fatty amides, polyalkoxylated non-quaternized fatty amines, polyalkoxylated mono- and diglycerides and, if appropriate, polyalkoxylated alkylpolyglycosides, preferably selected from polyalkylglucosides and sugar ester alkoxylates.

Examples of particularly suitable fatty alcohols and polyalkoxylated oxo alcohols are those of the general formula I

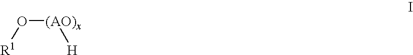

in which the variables are defined as follows:
R¹ is branched or straight-chain C₆-C₃₀-alkyl or C₆-C₃₀-alkenyl, preferably C₈-C₂₀-alkyl or C₅-C₂₀-alkenyl, it being possible for C₆-C₃₀-alkenyl to have one or more C—C double bonds which may preferably have a (Z)-configuration,
AO is C₂-C₄-alkylene oxide, identical or different, for example butylene oxide CH(C₂H₅)CH₂O, propylene oxide CH(CH₃)CH₂O and in particular ethylene oxide CH₂CH₂O,
x is a number in the range from 2 to 100, it also being possible for the average value (number average) of x to be a nonintegral number, preferably in the range from 2 to 90 and particularly preferably from 2.5 to 80.

Where AO are different alkylene oxides, the different alkylene oxides may be arranged in blocks or randomly.

Examples of particularly suitable polyalkoxylated fatty alcohols and oxo alcohols are

n-C₁₈H₃₇O—(CH₂CH₂O)₈₀—H,
n-C₁₈H₃₇O—(CH₂CH₂O)₇₀—H,
n-C₁₈H₃₇O—(CH₂CH₂O)₆₀—H,
n-C₁₈H₃₇O—(CH₂CH₂O)₅₀—H,
n-C₁₈H₃₇O—(CH₂CH₂O)₂₅—H,
n-C₁₈H₃₇O—(CH₂CH₂O)₁₂—H,
n-C₁₆H₃₃O—(CH₂CH₂O)₈₀—H,
n-C₁₆H₃₃O—(CH₂CH₂O)₇₀—H,
n-C₁₆H₃₃O—(CH₂CH₂O)₆₀—H,
n-C₁₆H₃₃O—(CH₂CH₂O)₅₀—H,
n-C₁₆H₃₃O—(CH₂CH₂O)₂₅—H,
n-C₁₆H₃₃O—(CH₂CH₂O)₁₂—H,
n-C₁₂H₂₅O—(CH₂CH₂O)₁₁—H,
n-C₁₂H₂₅—(CH₂CH₂O)₁₈—H,
n-C₁₂H₂₅O—(CH₂CH₂O)₂₅—H,
n-C₁₂H₂₅O—(CH₂CH₂O)₅₀—H,
n-C₁₂H₂₅O—(CH₂CH₂O)₈₀—H,
n-C₃₀H₆₁O—(CH₂CH₂O)₈—H,
n-C₁₀H₂₁O—(CH₂CH₂O)₉—H,
n-C₁₀H₂₁O—(CH₂CH₂O)₇—H,
n-C₁₀H₂₁O—(CH₂CH₂O)₅—H,
n-C₁₀H₂₁O—(CH₂CH₂O)₃—H,
and mixtures of the abovementioned emulsifiers, for example mixtures of n-C₁₈H₃₇O—(CH₂CH₂O)₅₀—H and n-C₁₆H₃₃O—(CH₂CH₂O)₅₀—H,
the indices being regarded in each case as average values (number average).

Polyalkoxylated fatty acids and polyalkoxylated fatty amides are preferably selected from compounds of the general formulae II a and II b

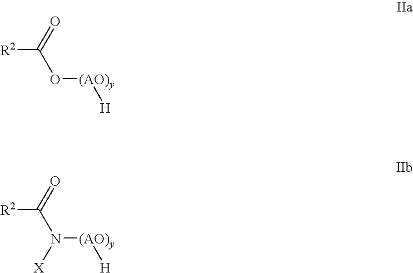

where
R² is selected from straight-chain or branched C₅-C₂₉-alkyl or C₅-C₂₉-alkenyl, preferably C₇-C₁₉-alkyl or C₇-C₁₉-alkenyl, it being possible for C₅-C₂₉-alkenyl to have one or more C—C double bonds which may preferably have a (Z)-configuration,
y is a number in the range from 1 to 50, it also being possible for the average value (number average) of y to be a nonintegral number, preferably in the range from 3 to 48,
X is hydrogen or (AO)ₜ-H, where t is a number in the range from 1 to 50, it also being possible for the average value (number average) of t to be a nonintegral number, preferably in the range from 3 to 48, and it being possible for y and t to be different or preferably identical.

Examples of compounds of the general formula II a are oleic acid alkoxylated with on average 5.5 equivalents of ethylene oxide, tallow fatty acid ethoxylated with on average from 3 to 10 equivalents and castor oil ethoxylated with on average from 35 to 48 equivalents, the average values being based in each case on number average.

Examples of compounds of the general formula II b are the monodecaethoxylate of oleamide (AO=ethylene oxide, y=10, X=hydrogen) and the bispentaethoxylate of oleamide (AO=ethylene oxide, y=5, X=(AO)₅) and the bisdecaethoxylate of oleamide (AO=ethylene oxide, y=10, X=(AO)₁₀.

Examples of polyalkoxylated fatty amines are preferably selected from compounds of the general formula II c

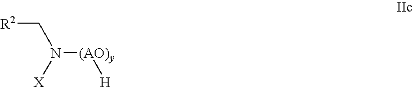

the variables being as defined above.

Compounds of the general formulae III a to III d

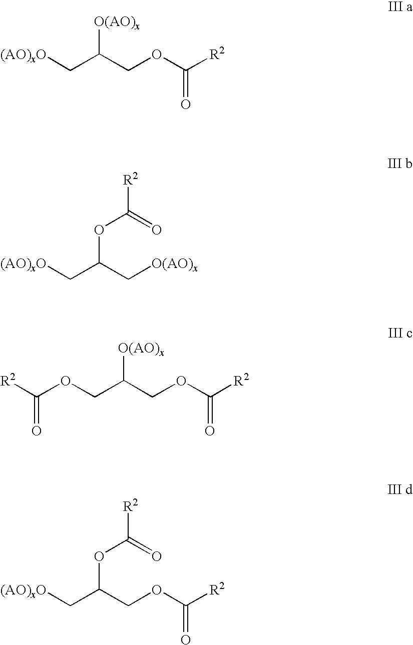

in which R² and x may be different or preferably identical and are as defined above, may be mentioned as examples of polyalkoxylated mono- and diglycerides.

In the context of the present invention, alkylpolyglycosides are preferably to be understood as meaning sugars etherified at the C1-position with C₁-C₂₀-alkanol, preferably with C₁₂-C₂₀-alkanol, in particular glucose etherified at the C1-position with C₁-C₂₀-alkanol, preferably with C₁₂-C₂₀-alkanol. As a result of the preparation process, alkylpolyglycosides are contaminated as a rule with C1-C6-linked di- and polyglycosides which, if appropriate, are etherified with C₁-C₂₀-alkanol. In an embodiment of the present invention, 1.3 equivalents of sugar are linked to one equivalent of C₁-C₂₀-alkanol.

In the context of the present invention, sugar ester alkoxylates are preferably to be understood as meaning sugar alcohols which are monoesterified or polyesterified with fatty acids and alkoxylated with from 5 to 80 equivalents of alkylene oxide, in particular with ethylene oxide. Preferred sugar ester alkoxylates are selected from alkoxylated sorbitan fatty acids, preferably sorbitol monoesterified or polyesterified with fatty acids and alkoxylated with from 5 to 80 equivalents of alkylene oxide, in particular ethylene oxide.

In an embodiment of the present invention, tanned animal hide treated according to the invention is removed from the liquor, for example by discharging the liquor, after step (A) has been carried out.

In another embodiment of the present invention, a step (B) is carried out, after step (A) has been carried out, by adding at least one silicone compound (d). For this purpose, it is preferable to add at least one silicone compound (d) to the liquor without removing tanned animal hide treated according to the invention from the liquor from step (A). Suitable silicone compounds (d) are, for example, silicone compounds containing carboxyl groups and mixtures of at least one silicone compound containing carboxyl groups and a silicone compound free of carboxyl groups.

Examples of silicone compounds containing carboxyl groups which are suitable as silicone compound (d) carry on average (number average) at least one, for example from one to 100, preferably up to 10, carboxyl groups per molecule, which carboxyl group may be partly or quantitatively neutralized with, for example, alkali, preferably potassium or sodium. The carboxyl group(s) may be linked, for example via a spacer, to a polysiloxane chain of the silicone compound(s) containing carboxyl groups, and the carboxyl group(s) may be present at any desired points of the polysiloxane chain of the silicone compound(s) containing carboxyl groups.

In an embodiment of the present invention, at least one silicone compound (d) has an average molecular weight Mₙ, in the range from 500 to 100 000 g/mol, preferably from 1000 to 50 000 g/mol.

The literature describes numerous silicone compounds which contain carboxyl groups and which may differ, for example, in the type of spacer, number of COOH groups per molecule, molecular weight and structure of the silicone chain.

The following may be mentioned by way of example for spacers: C₁-C₁₀₀-alkylene, preferably C₁-C₂₀-alkylene, for example —CH₂—, —CH₂—CH₂—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—, —(CH₂)₁₂—, —(CH₂)₁₄—, —(CH₂)₁₆—, —(CH₂)₁₈—, —(CH₂)₂₀—,

C₁-C₁₀₀-alkylene, mono- or polysubstituted by C₁-C₄-alkyl or —CH₂—COOH or phenyl, in which one or more non-neighboring carbon atoms can be identically or differently replaced by oxygen atoms or NH groups, for example —CH(CH₃)—, —CH(C₂H₅)—, —CH₂—CH(CH₃)—, —CH(C₆H₅)—, —CH₂—CH(C₂H₅)—, —CH₂—CH(CH[CH₃]₂)—, —CH₂—CH(n-C₃H₇)—, —[CH(CH₃)]₂—, —CH(CH₃)—CH₂—CH₂—CH(CH₃)—, —CH(CH₃)—CH₂—CH(CH₃)—, —CH₂—C(CH₃)₂—CH₂—, —CH₂—CH(n-C₄H₉)—, —CH₂—CH(t-C₄H₉)—, —CH₂—CH(C₆H₅)—,

—CH₂—O—, —CH₂—O—CH₂—, —CH₂CH₂—O—, —CH₂CH₂—O—CH₂CH₂—, —[CH₂CH₂—O]₂—(CH₂)₂—, —[CH₂CH₂—O]₃—CH₂CH₂—,

—CH—NH—, —(CH₂)₂—NH—, —(CH₂)₃—NH—, —(CH₂)₄—NH—, —(CH₂)₂—NH—CH₂—, —(CH₂)₂—NH—(CH₂)₂—, —(CH₂)₃—NH—(CH₂)₃—.

Further suitable spacers are C₆-C₂₀-arylene, C₇-C₂₁-alkylarylene and C₅-C₂₀-cycloalkylene, for example para-phenylene, meta-phenylene, 1,7-naphthylene, 2,6-naphthylene, 2-isopropylparaphenylene, 2-methyl-para-phenylene, cis- or trans-1,4-cyclohexylene, cis- or trans-1,2-cyclohexylene, cis- or trans-1,3-cyclopentylene or cis- or trans-1,2-cyclopentylene.

Further examples of suitable silicone compounds are described in WO 95/22627, EP-A 0 324 345, DE-A 42 40 274, EP-A 638 128, WO 98/21369, EP-A 1 510 554, EP-A 0 095 676, EP-A 0 299 596 and EP 0 415 204.

Suitable silicone compounds free of carboxyl groups are, for example, polydimethylsiloxanes and polymethylphenylsiloxanes which are liquid at room temperature.

Silicone compound (d) can be added, for example, in one or more portions to the liquor from step (A).

The treatment in step (B) may take from 30 to 120 minutes.

The treatment in step (B) may be carried out at the same pH as the treatment according to the invention in step (A). However, it is also possible to choose a pH which is in the range of up to one unit above or below the pH at which step (A) is carried out.

In an embodiment of the present invention, from 0.1 to 5% by weight, preferably from 0.2 to 2% by weight, of silicone compound (d), based on tanned animal hide to be treated (shaved weight), may be added.

Silicone compound (d) can be added as such or preferably in the form of one or more preferably aqueous formulations.

While the process according to the invention is being carried out, the following may be added in particular after step (A) has been carried out: one or more conventional leather dyes, one or more retanning agents, in particular resin tanning agents or vegetable tanning agents or sulfone tanning agents, or mixtures of the above-mentioned retanning agents.

After the process according to the invention has been carried out, washing, dyeing or fatliquoring can be effected by methods known per se, or other operations known per se for fulfilling the special fashion requirements may follow.

Leathers produced by the process according to the invention are distinguished by good softness and a particularly tight-grained character, and furthermore by fine grains and uniform dyeing. Compared with conventionally fatliquored leathers which have been rendered water repellent and have the same softness levels, the leathers are substantially more tight-grained and fuller. Furthermore, particularly when step (B) of the process according to the invention has also been carried out, it is observed that the leathers thus produced have very good water repellency compared with a treatment exclusively by step (B) or in liquor containing silicone from the outset. Furthermore, only little heat yellowing or none at all is observed, and the leathers produced by the process according to the invention are very lightfast and exhibit little fogging, the fogging values, determined gravimetrically according to DIN 75201, being as a rule less than 5 mg. Leather produced by the process according to the invention is suitable, for example, for the production of shoes and articles of apparel, but also for the production of leather furniture having excellent lightfastnesses.

Despite the use of, for example, short-chain paraffins and nonionic surfactants, no disadvantages with regard to the water repellency are observed.

The present invention furthermore relates to silicone-free aqueous formulations free of natural fats, comprising
(a) at least one copolymer obtainable by copolymerization of
   (a1) at least one ethylenically unsaturated C₄-C₈-dicarboxylic acid or at least one derivative of an ethylenically unsaturated C₄-C₈-dicarboxylic acid and
   (a2) at least one C₈-C₁₀₀-α-olefin
   and, if appropriate, hydrolysis and/or at least partial neutralization,
(b) at least one paraffin which is liquid at room temperature,
(c) if appropriate, at least one synthetic nonionic emulsifier.

In an embodiment of the present invention, aqueous formulations according to the invention have the following composition:

in the range from 5 to 40% by weight, preferably from 5 to 25% by weight, of copolymer (a),
in the range from 0.1 to 30% by weight, preferably from 2 to 20% by weight, of paraffin (b) liquid at room temperature and
in the range of altogether from 0 to 10% by weight, preferably from 0.5 to 8% by weight, of synthetic nonionic emulsifier (c),
data in % by weight being based in each case on the total formulation. The remainder is preferably water.

In an embodiment of the present invention, formulations according to the invention have a solids content in the range of from 5 to 80% by weight, preferably from 10 to 50% by weight, particularly preferably from 20 to 45% by weight.

In a special embodiment of the present invention, aqueous formulations according to the invention are aqueous emulsions having a mean drop diameter in the range of from 200 nm to 10 μm.

The present invention furthermore relates to a process for the preparation of formulations according to the invention, also referred to below as preparation process according to the invention, wherein
(a) at least one copolymer obtainable by copolymerization of
   (a1) at least one ethylenically unsaturated C₄-C₈-dicarboxylic acid or at least one derivative of an ethylenically unsaturated C₄-C₈-dicarboxylic acid and
   (a2) at least one C₈-C₁₀₀-α-olefin
   and, if appropriate, hydrolysis and/or at least partial neutralization,
(b) at least one paraffin which is liquid at room temperature,
(c) if appropriate, at least one synthetic nonionic emulsifier,
   are mixed with one another, for example by stirring.

In a special variant of the preparation process according to the invention
(a) at least one copolymer obtainable by copolymerization of
   (a1) at least one ethylenically unsaturated C₄-C₈-dicarboxylic acid or at least one derivative of an ethylenically unsaturated C₄-C₈-dicarboxylic acid and
   (a2) at least one C₈-C₁₀₀-α-olefin
   and, if appropriate, hydrolysis and/or at least partial neutralization,
(b) at least one paraffin which is liquid at room temperature and
(c) if appropriate, at least one synthetic nonionic emulsifier
   are mixed with the aid of an Ultra-Turrax.

After the actual mixing, aqueous formulations according to the invention can be further stabilized, for example by passing through a gap homogenizer.

Aqueous formulations according to the invention have a very long shelf life and are excellently suitable for carrying out the process according to the invention. A further aspect is the use of at least one aqueous formulation according to the invention for the production of leather. A further aspect of the present invention is a process for the production of leather using at least one formulation according to the invention.

A further aspect of the present invention is carrying out the process according to the invention for the production of leather using at least one formulation according to the invention. For this purpose, it is possible to provide an aqueous liquor, which can be prepared, for example, by diluting formulation according to the invention with water and allowing it to act on tanned animal hide.

The invention is explained by working examples.

The Maeser measurements and the water absorption were carried out using a Bally penetrometer. The Maeser measurements were carried out according to DIN 35338, in each case as double determinations. The static water absorption was carried out at 15% compression and stated in % by weight, based on the finished leather. The dyeing was assessed by visual inspection.

### 1. Preparation of the Starting Materials

### 1.1 Preparation of a Formulation F.1 According to the Invention

100 g of an alternating copolymer (a-1) of maleic anhydride (a1-1) and α-n-C₁₈H₃₈ (a2-1) having an average molecular weight Mₙ, of 5000 g/mol were stirred into 500 g of an aqueous sodium hydroxide solution which had been heated to 90° C. and comprised 1.2 equivalents of sodium hydroxide per maleic anhydride unit of (a-1).

The above-described solution of the sodium salt of (a-1) was initially taken in a stirred barrel and

(c-1.1) 15 g of an oxo alcohol ethoxylate (n-C₁₁H₂₃—OH, ethoxylated with 2.6 equivalents of ethylene oxide), HLB value: 8,
(c-2.1) 15 g of an oxo alcohol ethoxylate (n-C₁₁H₂₃—OH, ethoxylated with 9.1 equivalents of ethylene oxide), HLB value: 14
and then
(b-1) 80 g of a paraffin having a boiling range of from 125 to 230° C., determined at atmospheric pressure, and a dynamic viscosity of 1.44 mPa·s, determined at 20° C. were added. (b-1) was a mixture of a plurality of acyclic saturated hydrocarbons, and the proportion of branched acyclic saturated hydrocarbons was below 2% by weight (gas chromatography), based on the total amount of (b-1).

Stirring was effected over a period of 30 minutes, and aqueous formulation F.1 according to the invention, having a solids content of 35% by weight, was obtained. Aqueous formulation F.1 according to the invention comprised neither natural fats nor silicone.

### 1.2 Preparation of a Formulation F.2 According to the Invention

100 g of alternating copolymer (a-2) of 1 equivalent of maleic anhydride (a1-1), 0.5 equivalent of α-n-C₁₆H₃₂ (a2-2) and 0.5 α-n-C₂₀₋₂₄-olefin (a2-3) having an average molecular weight Mₙ, of 6000 g/mol were stirred into 500 g of an aqueous sodium hydroxide solution which had been heated to 90° C. and comprised 1.2 equivalents of sodium hydroxide per maleic anhydride unit of (a-2).

The above-described solution of the sodium salt of (a-2) was initially taken in a stirred barrel and

(c-1.1) 15 g of an oxo alcohol ethoxylate (n-C₁₁H₂₃—OH, ethoxylated with 2.6 equivalents of ethylene oxide), HLB value: 8,
(c-2.1) 15 g of an oxo alcohol ethoxylate (n-C₁₁H₂₃—OH, ethoxylated with 9.1 equivalents of ethylene oxide), HLB value: 14
and then
(b-1) 80 g of a paraffin having a boiling range of from 125 to 230° C., determined at atmospheric pressure, and a dynamic viscosity of 1.44 mPa·s, determined at 20° C. were added. (b-1) was a mixture of a plurality of acyclic saturated hydrocarbons, and the proportion of branched acyclic saturated hydrocarbons was below 2% by weight (gas chromatography), based on the total amount of (b-1).

Stirring was effected over a period of 30 minutes, and aqueous formulation F.2 according to the invention, having a solids content of 35% by weight, was obtained. Aqueous formulation F.2 according to the invention comprised neither natural fats nor silicone.

### 1.3 Preparation of a Formulation F.3 According to the Invention

100 g of an alternating copolymer of 1 equivalent of maleic anhydride (a1-1), 0.5 equivalent of α-n-C₁₈H₃₆ and 0.5 equivalent of α-n-C₂₀₋₂₄ olefin having an average molecular weight Mₙ of 6000 g/mol (a.3) were stirred into 500 g of an aqueous sodium hydroxide solution which had been heated to 90° C. and comprised 1.2 equivalents of sodium hydroxide per maleic anhydride unit of (a.3).

The above-described solution of the sodium salt of (a.3) was initially taken in a stirred vessel and

(c-1.1) 15 g of an oxo alcohol ethoxylate (n-C₁₁H₂₃—OH, ethoxylated with 2.6 equivalents of ethylene oxide), HLB value: 8,
(c-2.1) 15 g of an oxo alcohol ethoxylate (n-C₁₁H₂₃—OH, ethoxylated with 9.1 equivalents of ethylene oxide), HLB value: 14
and then
(b.3) 80 g of a paraffin having a boiling range of from 125 to 230° C., determined at atmospheric pressure, and a dynamic viscosity of 1.44 mPa·s, determined at 20° C. were added. (b.3) was a mixture of a plurality of acyclic saturated hydrocarbons, and the proportion of branched acyclic saturated hydrocarbons was below 2% by weight (gas chromatography), based on the total amount of (b.3).

Stirring was effected over a period of 30 minutes, and aqueous formulation F.3 according to the invention, having a solids content of 35% by weight, was obtained. Aqueous formulation F.3 according to the invention comprised neither natural fats nor silicone.

1.4 Preparation of an Emulsion of a Silicone Compound (d-1)

The following were mixed in a 2 l container having a stirrer:

150 g of the silicone compound (d-1), kinematic viscosity 600 mm²/s: at 23° C., of the formula

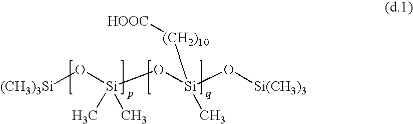

as a random cocondensate with q=3 and p=145 (average values in each case),

### 130 g of N-oleylsarcosine,

15 g of NaOH (solid)
153 g of slack wax (36/38° C.; Shell)
450 ml of water
The resulting emulsion of silicone compound (d-1) had a pH of 8.5.
1.5 Preparation of an Emulsion of a Silicone Compound (d-2)

The procedure was as described in EP 0 324 345 B1, example 1. The resulting emulsion of silicone compound (d-2) had a pH of 8.5

### 2. Treatment of Tanned Animal Hide

Data in % by weight are based below on the shaved weight, unless stated otherwise.

### 2.1 Use Example A

Chrome-tanned cattle leather (wet blue) having a shaved thickness of from 2.0 to 2.2 mm was mixed with 100% by weight of water in a rotatable barrel having baffles and was acidified with 2% by weight of sodium formate and 0.8% by weight of NaHCO₃ to a pH of 5.3. Thereafter, washing with water was effected and then 100% by weight of water (35° C.) were added. 4% by weight of formulation F.1 according to the invention were added and were allowed to act with occasional rotation of the barrel. After an action time of 40 minutes, 2% by weight of a resin tanning agent (melamine/formaldehyde condensate) were added and allowed to act for a duration of 40 minutes with occasional rotation of the barrel. The following were then added: 3% by weight of sulfone tanning agent from EP-B 0 459 168, example K1, and 3% by weight of a commercial mimosa extract, and drumming was effected for a duration of 60 minutes. 2% by weight of a 50% by weight (solids content) aqueous solution of dyes were then metered, the solids of which solution had the following composition:

70 parts by weight of dye from EP-B 0 970 148, example 2.18,
30 parts by weight of Acid Brown 75 (iron complex), Colour Index 1.7.16;
and drumming was effected for a further 60 minutes. 4% by weight of an emulsion of silicone compound (d-1) from example 1.4 were then added (Step B). Drumming was effected for a further hour and acidification with formic acid to a pH of 3.6 and washing with water were carried out.

The dyeing was then fixed by drumming for 90 minutes in a tanning drum in the presence of 3% by weight of chrome tanning agent (basic Cr(III) sulfate).

Washing was effected again, mechanical staking and drying were carried out and finishing was effected by methods known per se. Leather L.1 produced according to the invention was obtained.

For comparison, the procedure as described above was employed but, instead of formulation F.1 according to the invention, an identical amount (based on the solid) of 4% of a 30% by weight aqueous, partly NaOH-neutralized solution of an acrylic acid homopolymer having the following analytical data was used: Mₙ about 10 000 g/mol, pH 5.1. Comparative leather V-L.2 was obtained.

Visual comparison: the dyeing of leather L.1 produced by the process according to the invention was more level and more uniform than that of V-L.2. Leather L.1 was substantially softer and more tight-grained and had very good fullness. Furthermore, it showed no tendency toward fogging and toward heat yellowing even after several days.

### Maeser Test:

L.1: about 27 000 flexes up to water penetration,
V-L.2 300 flexes up to water penetration.

### 2.2 Use Example B

Chrome-tanned cattle leather (wet blue) having a shaved thickness of from 1.0 to 1.2 mm was mixed with 100% by weight of water in a rotatable barrel having baffles and was acidified with 2% by weight of sodium formate and 0.8% by weight of NaHCO₃ to a pH of 5.3. Thereafter, washing with water was effected and then 100% by weight of water (35° C.) were added. 4% by weight of formulation F.2 (addition 1) according to the invention were added and were allowed to act with occasional rotation of the barrel. After an action time of 40 minutes, 2% by weight of a resin tanning agent (melamine/formaldehyde condensate) were added and allowed to act for a duration of 40 minutes with occasional rotation of the barrel. A further 8% by weight of formulation F.2 according to the invention (addition 2) were then added and drumming was effected for a further 60 minutes. Thereafter, acidification with 80% by weight of formic acid to a pH of 3.6, drumming for a further 30 minutes and washing with water were effected.

Mechanical staking and drying were effected and finishing was carried out by methods known per se. Leather L.3 produced according to the invention was obtained.

For comparison, the procedure as described above was employed but, instead of formulation F.2 according to the invention, 14% by weight of a 30% by weight aqueous, partly NaOH-neutralized dispersion (pH 5.3) of polymethacrylic acid (M_{w} 10 000 g) were used in the case of the first addition. Addition 2 was omitted. Comparative leather V-L.4 was obtained.

Visual comparison: Leather L.3 was substantially fuller and more tight-grained than comparative leather V-L.4 and had very good fullness in combination with comparable softness. Furthermore, it showed no tendency toward fogging (fogging values determined gravimetrically as 2-2.5 mg according to DIN 75201). The heat yellowing (6 days at 100° C., assessment based on gray scale) was substantially less in the case of leather L.3 (rating 6) than in the case of comparative leather V-L.4 (rating 2-3).

### 2.3 Use Example C

Chrome-tanned cattle leather (wet blue) having a shaved thickness of from 1.0 to 1.2 mm was mixed with 100% by weight of water in a rotatable barrel having baffles and was acidified with 2% by weight of sodium formate and 0.8% by weight of NaHCO₃ to a pH of 5.3.4% by weight of formulation F.3 according to the invention were added and were allowed to act with occasional rotation of the barrel. After an action time of 120 minutes, the liquor was discharged and washed with water, and 75% by weight of water (35° C.) were then added. Thereafter, 2% by weight of a resin tanning agent (melamine/formaldehyde condensate) were added and allowed to act for a duration of 40 minutes with occasional rotation of the barrel. The following were then added: 3% by weight of sulfone tanning agent from EP-B 0 459 168, example K1, and 3% by weight of a commercially available Mimosa extract, and drumming was effected for a duration of 60 minutes. 2% by weight of a 50% by weight (solids content) aqueous solution of dyes were then metered, the solids of which solution had the following composition:

70 parts by weight of dye from EP-B 0 970 148, example 2.18,
30 parts by weight of Acid Brown 75 (iron complex), Color Index 1.7.16;
and drumming was effected for a further 60 minutes. 4% by weight of an emulsion of silicone compound (d-2) from example 1.5 were then added (Step B). Drumming was effected for a further hour and acidification with formic acid to a pH of 3.6 and washing with water were carried out.

The dyeing was then fixed by drumming for 90 minutes in a tanning drum in the presence of 3% by weight of chrome tanning agent (basic Cr(III) sulfate).

Washing was effected again, mechanical setting out and drying were carried out and finishing was effected by methods known per se. Leather L.5 produced according to the invention was obtained.

For comparison, the procedure as described above was employed but the addition of the formulation F.3 according to the invention was omitted. Instead, 6% by weight of the emulsion of silicone compound (d-2) according to example 1.5 were added in the retanning. Comparative leather V-L.6 was obtained.

Visual comparison: leather L.5 was substantially softer and substantially more tight-grained and fuller, in particular in the belly and flank.

### Maeser Test:

L.5: >100 000 flexes up to water penetration,
V-L.6 about 1400 flexes up to water penetration.

L.5 moreover has an extremely good consistency of the Maeser values over the area of the hide. Usually, the Maeser values decrease substantially, not rarely by 50% or more, in the head and belly region compared with the values in the butt and back. On leather L.5, the following values were measured in a double determination:

butt: >100 000/>100 000
back: >100 000/>100 000
shoulder: >100 000/>100 000
head: >16 000/>100 000
flank: >100 000/>100 000
belly: >100 000/>100 000

1. A process for the production of leather, wherein tanned animal hides are treated in step (A) with an aqueous liquor which comprise:
(a) at least one copolymer obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin;
and, if appropriate, hydrolysis and/or at least partial neutralization,
(b) at least one paraffin which is liquid at room temperature; and
(c) at least one synthetic nonionic emulsifier,
the aqueous liquor being free of silicones.

2. The process according to claim 1, wherein at least two synthetic nonionic emulsifiers (c1) and (c2) are used.

3. The process according to claim 1, wherein at least one silicone compound (d) is added in step (B) after preparation according to step (A).

4. The process according to claim 1, wherein copolymer (a) has a molecular weight M_{w} in the range from 800 to 50 000 g/mol.

5. The process according to claim 1, wherein at least one synthetic nonionic emulsifier (c) is selected from polyalkoxylated fatty alcohols and polyalkoxylated oxo alcohols.

6. A silicone-free aqueous formulation free of natural fats, comprising:
in the range from 5 to 40% by weight of copolymer (a) obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin;
and, if appropriate, hydrolysis and/or at least partial neutralization,
in the range from 0.1 to 30% by weight of paraffin (b) liquid at room temperature; and
in the range of altogether from 0.5 to 10% by weight of synthetic nonionic emulsifier (c), data in % by weight being based in each case on the total formulation.

7. A process for the preparation of formulations according to claim 6, wherein:
(a) at least one copolymer obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin;
and, if appropriate, hydrolysis and/or at least partial neutralization,
(c) at least one paraffin which is liquid at room temperature; and
(d) at least one synthetic nonionic emulsifier,
are mixed with one another.

8. (canceled)

9. A process for the production of leather using at least one formulation according to claim 6.

10. The process for the production of leather according to claim 1, using at least one silicone-free aqueous formulation free of natural fats, comprising:
in the range from 5 to 40% by weight of copolymer (a) obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin;
and, if appropriate, hydrolysis and/or at least partial neutralization,
in the range from 0.1 to 30% by weight of paraffin (b) liquid at room temperature; and
in the range of altogether from 0.5 to 10% by weight of synthetic nonionic emulsifier (c), data in % by weight being based in each case on the total formulation.

11. The process according to claim 2, wherein at least one silicone compound (d) is added in step (B) after preparation according to step (A).

12. The process according to claim 2, wherein copolymer (a) has a molecular weight M_{w} in the range from 800 to 50 000 g/mol.

13. The process according to claim 3, wherein copolymer (a) has a molecular weight M_{w} in the range from 800 to 50 000 g/mol.

14. The process according to claim 2, wherein at least one synthetic nonionic emulsifier (c) is selected from polyalkoxylated fatty alcohols and polyalkoxylated oxo alcohols.

15. The process according to claim 3, wherein at least one synthetic nonionic emulsifier (c) is selected from polyalkoxylated fatty alcohols and polyalkoxylated oxo alcohols.

16. The process according to claim 4, wherein at least one synthetic nonionic emulsifier (c) is selected from polyalkoxylated fatty alcohols and polyalkoxylated oxo alcohols.

17. The process for the production of leather according to claim 2, using at least one silicone-free aqueous formulation free of natural fats, comprising:
in the range from 5 to 40% by weight of copolymer (a) obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin;
and, if appropriate, hydrolysis and/or at least partial neutralization,
in the range from 0.1 to 30% by weight of paraffin (b) liquid at room temperature; and
in the range of altogether from 0.5 to 10% by weight of synthetic nonionic emulsifier (c), data in % by weight being based in each case on the total formulation.

18. The process for the production of leather according to claim 2, using at least one silicone-free aqueous formulation free of natural fats, comprising:
in the range from 5 to 40% by weight of copolymer (a) obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin;
and, if appropriate, hydrolysis and/or at least partial neutralization,
in the range from 0.1 to 30% by weight of paraffin (b) liquid at room temperature; and
in the range of altogether from 0.5 to 10% by weight of synthetic nonionic emulsifier (c), data in % by weight being based in each case on the total formulation.

19. The process for the production of leather according to claim 3, using at least one silicone-free aqueous formulation free of natural fats, comprising:
in the range from 5 to 40% by weight of copolymer (a) obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin;
and, if appropriate, hydrolysis and/or at least partial neutralization,
in the range from 0.1 to 30% by weight of paraffin (b) liquid at room temperature; and
in the range of altogether from 0.5 to 10% by weight of synthetic nonionic emulsifier (c), data in % by weight being based in each case on the total formulation.

20. The process for the production of leather according to claim 4, using at least one silicone-free aqueous formulation free of natural fats, comprising:
in the range from 5 to 40% by weight of copolymer (a) obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin;
and, if appropriate, hydrolysis and/or at least partial neutralization,
in the range from 0.1 to 30% by weight of paraffin (b) liquid at room temperature; and
in the range of altogether from 0.5 to 10% by weight of synthetic nonionic emulsifier (c), data in % by weight being based in each case on the total formulation.

21. The process for the production of leather according to claim 5, using at least one silicone-free aqueous formulation free of natural fats, comprising:
in the range from 5 to 40% by weight of copolymer (a) obtainable by copolymerization of
(a1) at least one ethylenically unsaturated C₄-C₈-dicarboxylic acid or at least one derivative of an ethylenically unsaturated C₄-C₈-dicarboxylic acid and
(a2) at least one C₈-C₁₀₀-α-olefin;
and, if appropriate, hydrolysis and/or at least partial neutralization,
in the range from 0.1 to 30% by weight of paraffin (b) liquid at room temperature; and
in the range of altogether from 0.5 to 10% by weight of synthetic nonionic emulsifier (c), data in % by weight being based in each case on the total formulation.
